(19) United States
(12) Patent Application Publication
(10) Pub. No.: US 2026/0322009 A1
(43) Pub. Date: Oct. 15, 2026

(54) POWER CONNECTOR

(71) Applicant: FOXCONN INTERCONNECT TECHNOLOGY LIMITED, Grand Cayman (KY)

(72) Inventor: YU-KE CHEN, Zhengzhou (CN)

(21) Appl. No.: 19/645,289

(22) Filed: Apr. 13, 2026

(30) Foreign Application Priority Data
Apr. 11, 2025 (CN) 202510460094.9
Apr. 11, 2025 (CN) 202520691600.0

(51) Int. Cl. H01R 12/72; H01R 13/10; H01R 13/502; H01R 13/642

(52) U.S. Cl. CPC H01R 12/727; H01R 12/724; H01R 13/10; H01R 13/502; H01R 13/642

(57) ABSTRACT

A power connector includes an insulating housing with a mating face, plurality first power terminals fixed to the insulating housing, plural second power terminals fixed to the insulating housing, and plural signal terminals fixed to the insulating housing. The mating face of the insulating housing has two opposite long sides extending along a first direction and two opposite short sides extending along a second direction perpendicular to the first direction. The plural first power terminals are arranged along a first direction to form a first power terminal row, the plural second power terminals are arranged along the first direction to form a second power terminal row, and the plural signal terminals are positioned between the first power terminal row and the second power terminal row along the second direction.

### BACKGROUND OF THE INVENTION

### Field of the Invention

The present invention relates to a power connector.

### Description of Related Arts

U.S. Pat. No. 11,437,746 provides a board-end connector and a wire-end connector, which can be interlocked to form a wire-to-board connector element. The board-end connector includes a board-end insulating housing, a plurality of board-end terminals, and a plurality of board-end signal terminals. The board-end insulating housing has a board-end power insertion portion and a board-end signal insertion portion. The board-end signal insertion portion is positioned at one side of the board-end power insertion portion and has an elongated signal slot. The board-end terminals are housed within the board-end power insertion portion. Multiple board-end signal terminals are housed in the elongated signal slot of the board-end signal insertion portion. Compared to known separate power and signal transmission connection methods, this method combines power and signal transmission, simplifying the connection process and saves space, conforming to the current trend of miniaturization.

However, the power connector is positioned on the panel of the server device, and is not suitable for some applications with strict size requirements. Therefore, it is desirable to design an improved power connector.

### SUMMARY OF THE INVENTION

A power connector includes an insulating housing with a mating face, a plurality of first power terminals fixed to the insulating housing, a plurality of second power terminals fixed to the insulating housing, and a plurality of signal terminals fixed to the insulating housing. The mating face of the insulating housing has two opposite long sides extending along a first direction and two opposite short sides extending along a second direction perpendicular to the first direction. The plurality of first power terminals are arranged along a first direction to form a first power terminal row, the plurality of second power terminals are arranged along the first direction to form a second power terminal row, and the plurality of signal terminals are positioned between the first power terminal row and the second power terminal row along the second direction.

### BRIEF DESCRIPTION OF DRAWINGS

FIG. 1 shows a perspective view of a socket connector according to a first embodiment of the present disclosure;

FIG. 2 shows another perspective view of the socket connector of FIG. 1;

FIG. 3 shows a front view of the socket connector of FIG. 1;

FIG. 4 shows an exploded view of the socket connector of FIG. 1;

FIG. 5 shows a perspective view of a plug connector according to the first embodiment of the present disclosure;

FIG. 6 shows a top view of the plug connector of FIG. 5;

FIG. 7 shows an exploded view of the plug connector of FIG. 5;

FIG. 8 shows a perspective view of a portion of an elongated post and two signal terminals of FIG. 7;

FIG. 9 shows a perspective view of a first and second power terminal of FIG. 7;

FIG. 10 shows a cross-sectional view of the socket connector and the plug connector according to the first embodiment of the present disclosure;

FIG. 11 shows a perspective view of a socket connecter according to a second embodiment of the present disclosure;

FIG. 12 shows a top view of the socket connector of FIG. 11;

FIG. 13 shows a socket connector according to a third embodiment of the present disclosure;

FIG. 14 shows a front view of the socket connecter of FIG. 13;

FIG. 15 shows a perspective view if a socket connector according to a fourth embodiment of the present disclosure;

FIG. 16 shows a top view of the socket connector of FIG. 15; and

FIG. 17 shows an exploded view of the socket connector of FIG. 16.

### DETAILED DESCRIPTION OF THE DRAWINGS

The following detailed description in conjunction with the accompanying drawings further illustrates the present disclosure.

The present disclosure discloses a power connector including two rows of power terminals and a plurality of signal terminals. The signal terminals are positioned between the two rows of power terminals. Thus, positioning the power terminals on two sides of the signal terminals increases the heat dissipation surface area of the power terminals, thereby facilitating heat dissipation. The power terminals are relatively larger than the signal terminals, and the two rows of power terminals on two sides of the signal terminals prevent damage to the signal terminals during improper insertion. In some cases, the symmetrical structure allows the power connector to be inserted at different orientations.

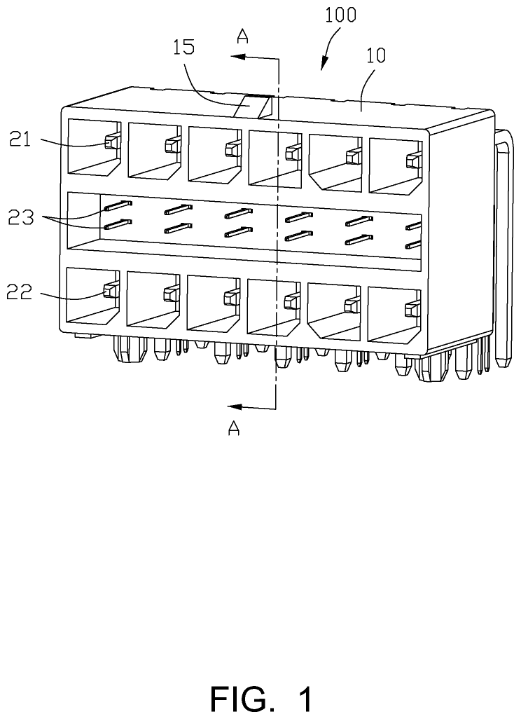

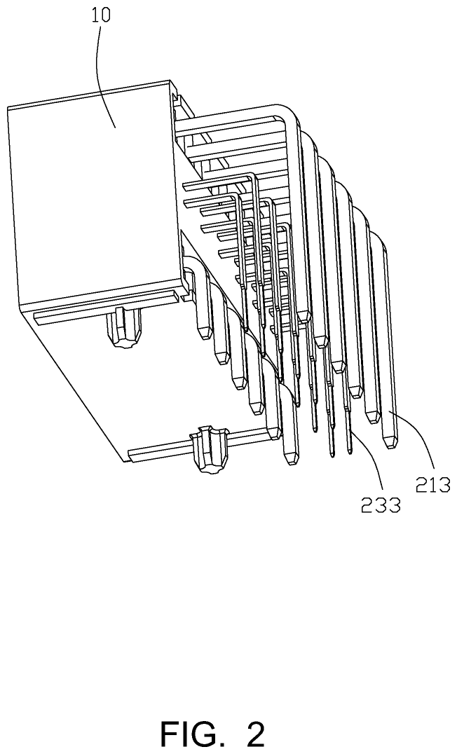

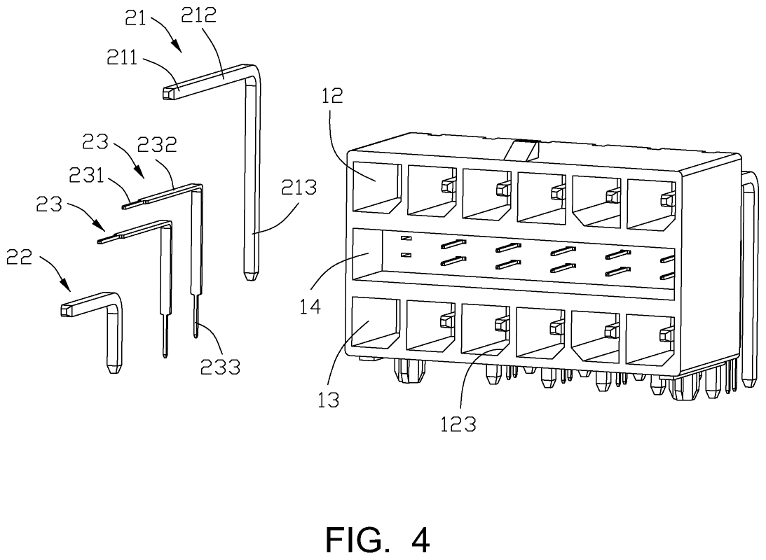

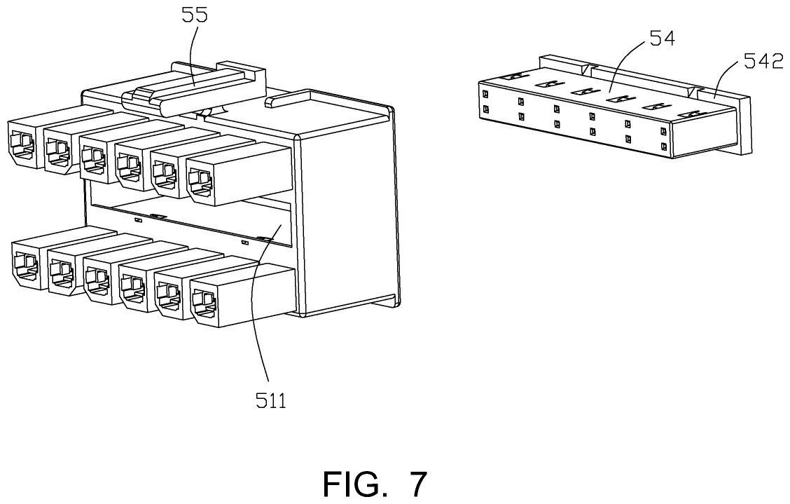

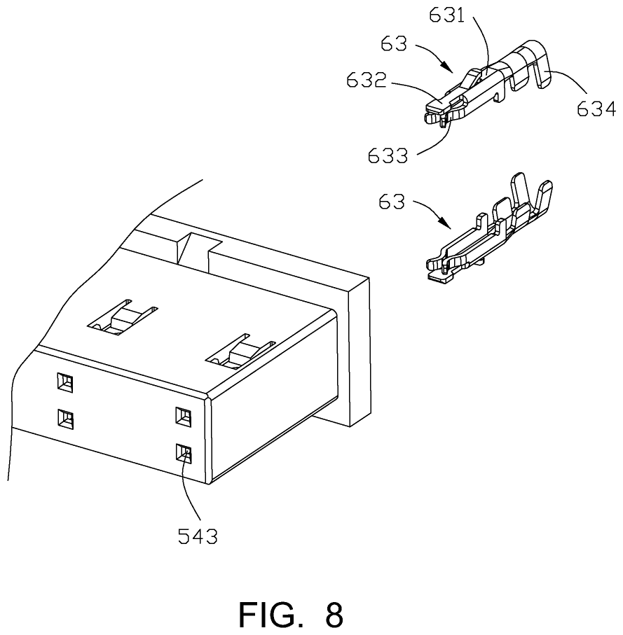

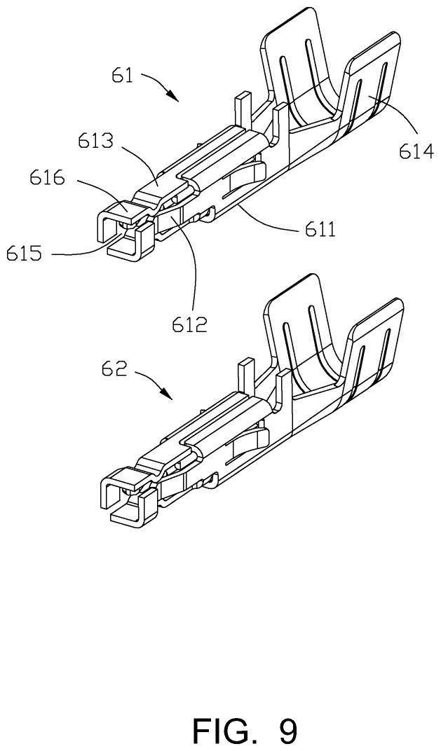

FIGS. 1-10 show a first embodiment of the present disclosure, the power connector assembly includes a socket connector 100 and a plug connector 200. The power connector is applicable to both the socket connector 100 and the plug connector 200. A detailed description of the first embodiment follows.

Referring to FIGS. 1-4, the socket connector 100 of the first embodiment is an angled socket connector. After being mounted on a circuit board, the mating direction of the socket connector 100 is parallel to the circuit board. The socket connector 100 includes an insulating housing 10 and a plurality of first power terminals 21, a plurality of second power terminals 22, and a plurality of signal terminals 23 fixed to the insulating housing 10. The plurality of first power terminals 21 are arranged along a first direction (left-right direction shown in the figures) to form a first power terminal row. The plurality of second power terminals 22 are arranged along the first direction to form a second power terminal row. The plurality of signal terminals 23 are arranged along the first direction. The signal terminals 23 are aligned to the first power terminals 21 and the second power terminals 22 in a second direction (up-down direction shown in the figures). The first and second directions are perpendicular to each other. The two rows of power terminals 21, 22 are positioned on both sides of the signal terminals 23, preventing damage to the signal terminals 23 during improper insertion. Simultaneously, compared to the first and second power terminal rows positioned adjacent to each other, the first and second power rows positioned on both sides of the signal terminals provide more space for heat dissipation. In some cases, the symmetrical structure, especially when the terminal holes do not have an inner chamfer, allows the plug connector to be inserted regardless of the orientation.

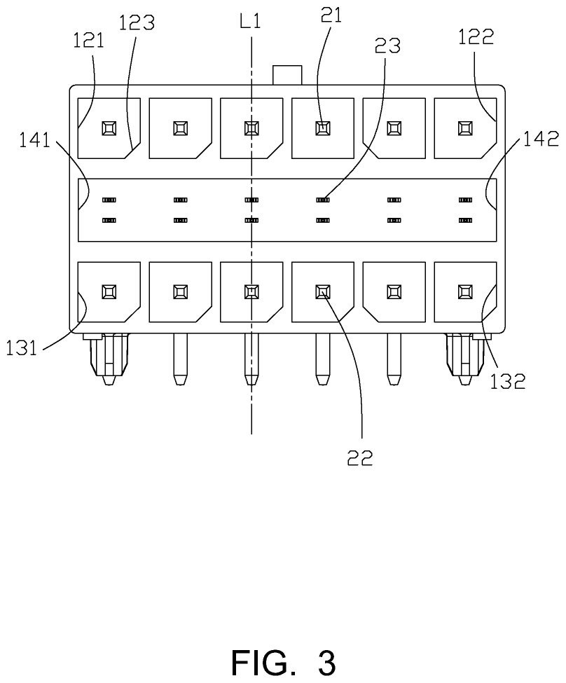

In the present embodiment, the insulating housing 10 has a plurality of first sockets 12, a plurality of second sockets 13, and a slot 14. The plurality of first sockets 12 are arranged along the first direction to form a first socket row, and the plurality of second sockets 13 are arranged along the first direction to form a second socket row. The slot 14 is positioned between the first socket row and the second socket row in a second direction. Each of the first sockets 12 accommodates one of the first power terminals 21, and each of the second sockets 13 accommodates one of the second power terminals 22. The slot 14 accommodates the signal terminals 23. In the present embodiment, viewed from the mating direction (as shown in FIG. 3), the plurality of first sockets 12 have differently oriented inner chamfers 123 to suit different application scenarios and avoid mis-insertion between different systems. Similarly, the plurality of second sockets 13 have differently oriented inner chamfers, and the first and second sockets are also asymmetrical.

In the present embodiment, in the second direction, the first power terminal 21, the signal terminal 23, and the second power terminal 22 are aligned with each other, as shown by the dashed line L1 in FIG. 3. Furthermore, in the present embodiment, the spacing between neighboring first power terminals 21 is 3 mm, the spacing between neighboring second power terminals 22 is 3 mm, and the spacing between neighboring signal terminals 23 is 3 mm. Thus, the spacing of the signal terminals 23 is the same as the spacing of the power terminals, simplifying the design. In some other embodiments, the spacing between neighboring first power terminals 21 along the first direction is the same as the spacing between neighboring second power terminals 22 along the first direction, but the spacing between neighboring signal terminals 23 along the first direction is less than or greater than the spacing between neighboring first power terminals along the first direction. In other embodiments, the spacing between neighboring power terminals can be 2.5 mm, 3.5 mm, or 5.7 mm to accommodate power transmission of different amperes.

In the present embodiment, the signal terminals 23 are arranged in two rows in the slot 14. In some other embodiments, the signal terminals 23 are arranged in a single row in the slot 14.

In the present embodiment, the first power terminal 21 and the second power terminal 22 are pin terminals, and the signal terminal 23 is also a pin terminal. In the present embodiment, the first and second power terminals have the same structure, and their dimensions are greater than those of the signal terminal 23. The first power terminal 21 includes a contact portion 211 exposed in the first socket 12, a fixing portion 212 fixed to the insulating housing, and a leg portion 213 extending out of the insulating housing. The first power terminal 21 is an L-shaped structure having the same front and rear dimensions, and is used in angled socket connectors. The second power terminal 22 has a similar structure as the first power terminal 21, and a smaller length. In the present embodiment, the signal terminal 23 includes a contact portion 231, a fixing portion 232 fixed to the insulating housing, and a leg portion 233 extending out of the insulating housing. The signal terminal 23 is thinner than the first/second power terminal in the second direction, and the contact portion 231 is wider than the fixing portion 232 in the first direction.

In the present embodiment, as shown in FIG. 3, the plurality of first sockets 12 has a first outermost inner edge 121 and a second outermost inner edge 122 opposite each other along the first direction. The plurality of second sockets 13 has a third outermost inner edge 131 and a fourth outermost inner edge 141 opposite each other along the first direction. The slot 14 has a fourth outermost inner edge 141 and a fifth outermost inner edge 142 opposite each other along the first direction. The first, third, and fifth outermost inner edges 121, 131, and 141 are aligned with each other in the second direction. The second, fourth, and sixth outermost inner edges 122, 132, and 142 are aligned with each other in the second direction. Thus, the plug connector can have a clean outer surface, increasing the connector's aesthetics.

The insulating housing has a retaining portion 15 on an outer surface proximal to the first power terminal 20. The retaining portion 15 is proximal to the mating face 110 of the insulating housing 10.

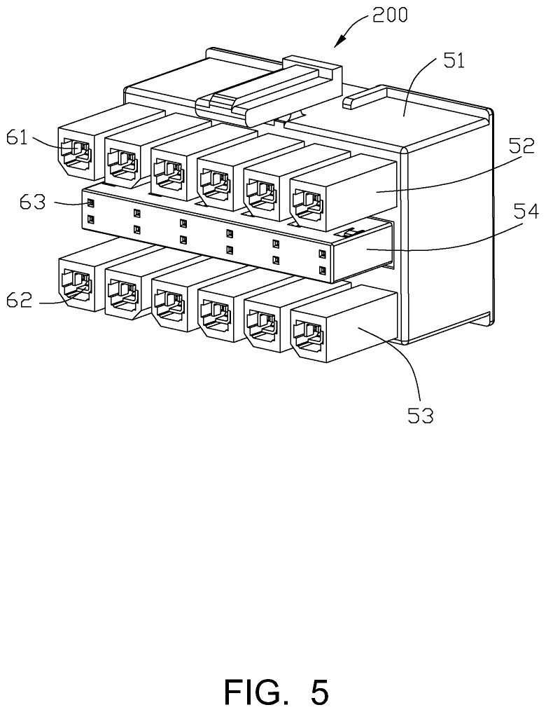

Referring to FIGS. 5-9, the plug connector 200 includes an insulating housing 50 and a plurality of first power terminals 61, a plurality of second power terminals 62, and a plurality of signal terminals 63. The insulating housing 50 includes a base portion 51 and a plurality of first posts 52, a plurality of second posts 53, and an elongated post 54 protruding from the base portion 51. Each of the first posts 52 accommodates a first power terminal 61, each of the second posts 53 accommodates a second power terminal 63, and the elongated post 54 accommodates a plurality of signal terminals 63.

In the present embodiment, the first post 52 and the second post 53 are formed by extending integrally from a face of the base portion 51, and the elongated post 54 is mounted onto the base portion 51, thus facilitating the molding of the insulating housing 50. The base portion 51 has a fixing groove 511. The elongated post 54 is assembled from rear to front in the fixing groove 511. The elongated post has an installation rib 542 at the rear end of thereof for abutting against the base portion 51.

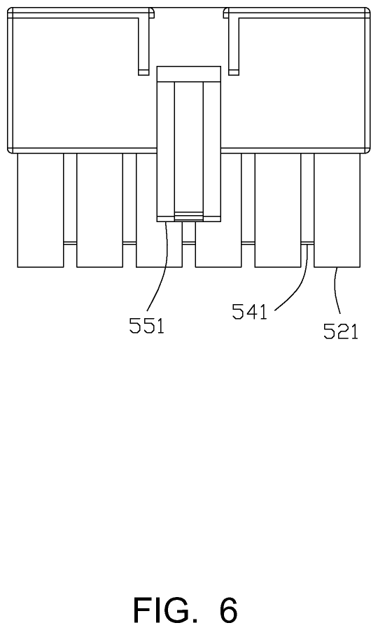

A retaining arm 55 is integrally formed on the base portion 51 near the first post 52. Referring to FIG. 6, a front end 541 of the elongated post 54 is positioned behind a front end 521 of the first post 52. A front end 551 of the retaining arm 55 is positioned behind the front end 541 of the elongated post. Namely, a length of the elongated post 54 is less than lengths of the first and second posts, and the first and second posts have the same length. Thus, given that the large and integrally formed first and second posts are on two sides of the elongated post 54, improper damage to the elongated post 54 can be prevented during mating.

The first and second power terminals 61 and 62 are both resilient terminals having a substantially similar structure. The first power terminal 61 includes a frame portion 611, two first resilient arms 612 and two second resilient arms 613 extending forward from the frame portion 611, and a connecting portion 614. The two first resilient arms 612 are opposite each other and each has a rear contact portion (not labeled), and the two second resilient arms 612 are opposite each other and each has a front contact portion (not labeled). The front contact portion is positioned in front of the rear contact portion. The four resilient arms form a contact channel 615 for accommodating a pin terminal. The front contact portion provides an electrical discharge function, and the rear contact portion provides a main electrical connection function. When the pin terminal is inserted, the contact portion of the pin terminal first contacts the front contact portion to perform an electrical discharge. Then, the contact portion of the pin terminal resiliently abuts the rear contact portion to achieve an electrical connection.

The first power terminal 61 further has two L-shaped portions 616. The rear edge of each L-shaped portion is integrally connected to the front edge of the front contact portion. Thus, the two L-shaped portions 616 form an entrance portion, which is in fluid communication with the contact channel 615.

The signal terminal 63 is also a flexible terminal, having a U-shaped portion 631, a horizontal portion 632 extending forward from the U-shaped portion, two resilient arms 633, and a connecting portion 634. The two resilient arms have contact portions. The contact portion of the signal terminal of the socket connector is inserted between the two resilient arms and contacts the contact portions, thereby achieving an electrical connection.

The first and second posts 52 and 53 have terminal holes 522 and 532. The first and second power terminals are inserted into and fixed in the corresponding terminal holes. The elongated post 54 has a plurality of terminal holes 543, and the signal terminals are inserted into and fixed in the terminal holes. The connecting portion 614 of the first and second power terminals is connected to a power cable (not shown), and the connecting portion 634 of the signal terminal is connected to a signal cable (not shown).

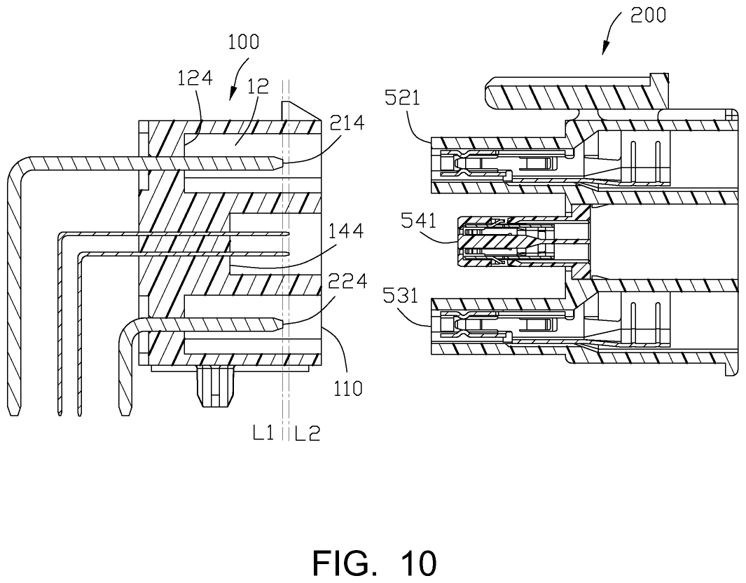

Referring to FIG. 10, the socket connector 100 and the plug connector 200 are mated together. The insulating housing 11 of the socket connector has a mating face 110. The first and second sockets 12, 13, and the slot 14 are recessed from the mating face 110. The recesses of the first and second sockets 12, 13 have the same depth, and the recess of the slot 14 is less than that of the first and second sockets. An inner bottom face 144 of the slot is closer to the mating face 110 than an inner bottom surface 124 of the first and second sockets. Furthermore, a front end 234 of the signal terminal 23 is closer to the mating face 110 than front ends 214, 224 of the first and second power terminals, as shown by the dashed line L2.

The front ends 521, 531 of the first and second posts 52, 53 of the plug connector are aligned with each other in the second direction. The front end 541 of the signal post 54 is positioned behind the front ends of the first and second posts, thus better protecting the elongated post 54. In some embodiments, the contact between the socket power terminals and the plug power terminals happens before the contact between the socket signal terminals and the plug signal terminals. Each row of power terminals includes six power terminals, and each row of signal terminals includes six signal terminals.

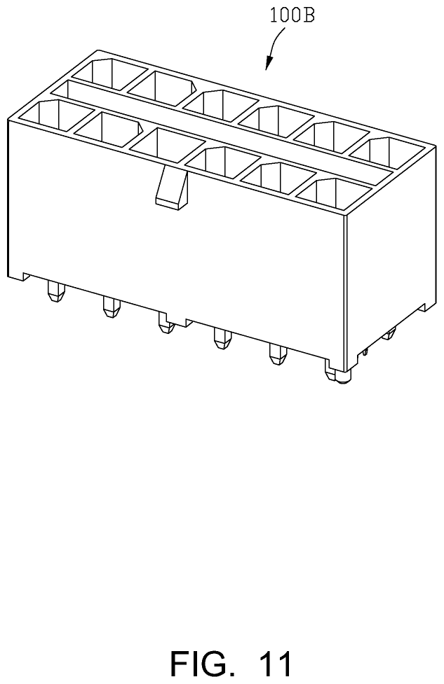

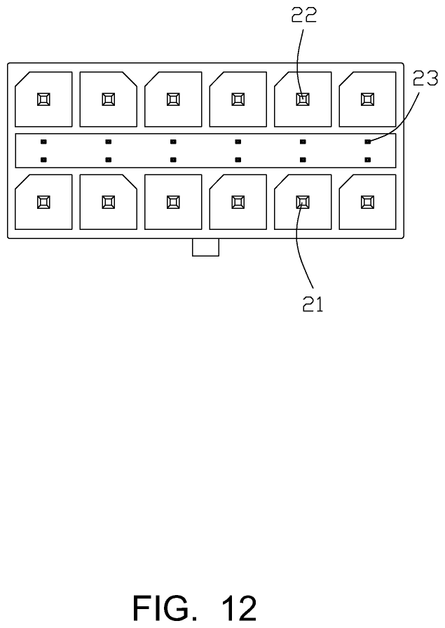

FIGS. 11-12 show a second embodiment of a socket connector 100B, which is a vertical connector. After the socket connector 100 is mounted on a circuit board, the mating direction thereof is perpendicular to the circuit board. The signal terminals 23 are arranged between the two rows of power terminals 21 and 22.

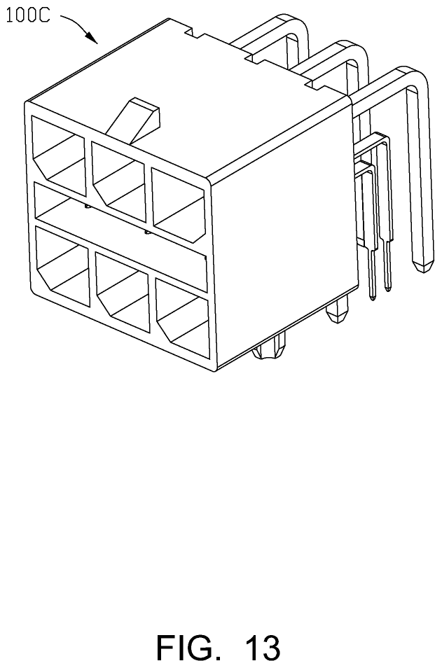

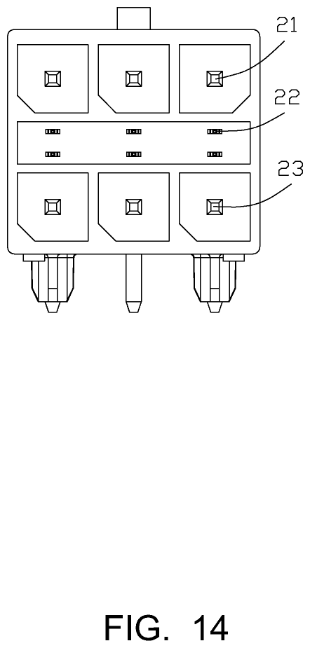

FIGS. 13-14 show a third embodiment of a socket connector 100C, which is an angled connector. In the present embodiment, each row of power terminals includes three power terminals, and each row of signal terminals includes three signal terminals.

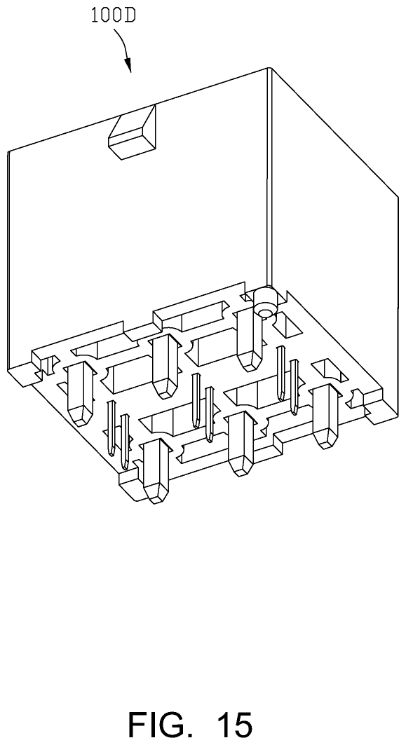

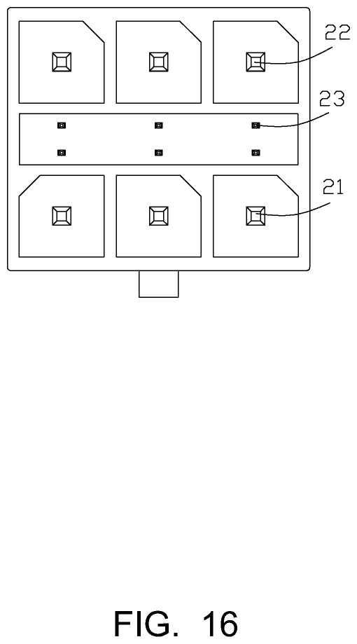

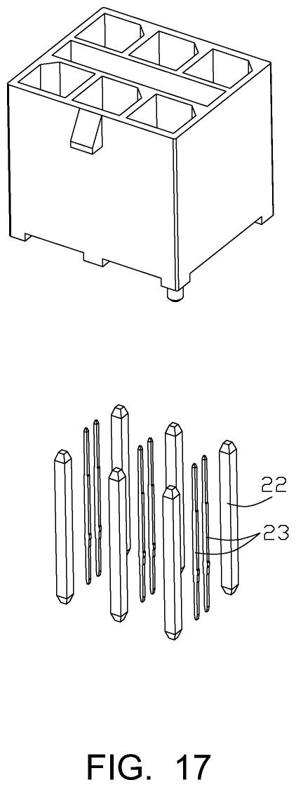

FIGS. 15-17 show a fourth embodiment of a socket connector 100D, which is a vertical connector. In the present embodiment, each row of power terminals includes three power terminals, and each row of signal terminals includes three signal terminals.

As can be seen from the above embodiments, in general or preferred implementation, the socket connector includes two rows of power terminals, and one or two rows of signal terminals positioned between the two rows of power terminals. The number of each power terminal can be expanded from two to more. In some other embodiments, the power terminal rows on both sides of the signal terminal row can be expanded to multiple rows, such as two rows of power terminals on each side. In an M*N matrix arrangement of power terminals, when M is greater than N, M defines the direction of the row. For example, in a 2*3 matrix arrangement of power terminals, each row of power terminals includes three power terminals. For example, in a 2*2 matrix arrangement, the direction of one row of power terminals can be decided.

In summary, the above are merely preferred embodiments of the present invention and should not be construed as limiting the scope of the invention. Any simple equivalent changes and modifications made in accordance with the claims and description of the present invention should still fall within the scope of the patent of the present invention.

1. A power connector comprising:
an insulating housing with a mating face;
a plurality of first power terminals fixed to the insulating housing;
a plurality of second power terminals fixed to the insulating housing; and
a plurality of signal terminals fixed to the insulating housing; wherein
the mating face of the insulating housing has two opposite long sides extending along a first direction and two opposite short sides extending along a second direction perpendicular to the first direction, the plurality of first power terminals are arranged along the first direction to form a first power terminal row, the plurality of second power terminals are arranged along the first direction to form a second power terminal row, and the plurality of signal terminals are positioned between the first power terminal row and the second power terminal row along the second direction.

2. The power connector of claim 1, wherein the first power terminals, the second power terminals, and the signal terminals are aligned with each other along the second direction.

3. The power connector of claim 1, wherein the power connector is a socket connector, the insulating housing has a plurality of first sockets and second sockets recessing from the mating face, and a slot, the plurality of first sockets are arranged along the first direction, the plurality of second sockets are arranged along the first direction, the slot is arranged between the first sockets and the second sockets, each of the first sockets accommodates one of the first power terminals, each of the second sockets accommodates one of the second power terminals, and the slot accommodates the plurality of signal terminals.

4. The power connector of claim 3, wherein a spacing between neighboring first power terminals along the first direction is the same as a spacing between neighboring second power terminals along the first direction, and a spacing between neighboring signal terminals along the first direction is less than or the same as the spacing between neighboring first power terminals along the first direction.

5. The power connector of claim 3, wherein the plurality of signal terminals are arranged in one row or two rows along the first direction in the slot.

6. The power connector of claim 3, wherein the first power terminals and the second power terminals are pin structures, and the signal terminals are pin structures.

7. The power connector of claim 3, wherein the plurality of first sockets has a first outermost inner edge and a second outermost inner edge opposite to each other along the first direction, the plurality of second sockets has a third outermost inner edge and a fourth outermost inner edge opposite to each other along the first direction, the slot has a fourth outermost inner edge and a fifth outermost inner edge opposite to each other along the first direction, the first, third, and fifth outermost inner edges are aligned with each other in the second direction, and the second, fourth, and sixth outermost inner edges are aligned with each other in the second direction.

8. The power connector of claim 3, wherein the insulating housing has a mating face, the first and second sockets and the slot are recessed from the mating face, the first and second sockets have the same recess depth, and the slot has a depth less than the recess depth of the first socket.

9. The power connector of claim 3, wherein the insulating housing has a mating face, the first and second sockets and the slot each have an inner bottom face, and the inner bottom face of the slot is closer to the mating face than the inner bottom faces of the first and second sockets.

10. The power connector of claim 1, wherein the power connector is a plug connector, the insulating housing comprises a base portion with the mating face, a plurality of first posts and second posts extending forward from the mating face, and an elongated post protruding forward from the mating face, each of the first posts accommodates one of the first power terminals, each of the second posts accommodates one of the second power terminals, and the elongated post accommodates the plurality of signal terminals.

11. The power connector of claim 10, wherein the first post, the second post, and the elongated post each have a front end, and the front end of the elongated post is positioned behind the front end of the first post and the front end of the second post.
